(19) United States
(12) Patent Application Publication
(10) Pub. No.: US 2002/0106201 A1
(43) Pub. Date: Aug. 8, 2002

(54) Structure of a hot packing bag

(76) Inventor: Chen-Shun Tseng, Taipei (TW)

Correspondence Address: Chen-Shun Tseng, PO Box 82-144, Taipei, TW

(21) Appl. No.: 09/776,841

(22) Filed: Feb. 6, 2001

(51) Int. Cl. H05B 3/00

(52) U.S. Cl. 392/339; 219/528; 126/263.01

(57) ABSTRACT

An improved structure of a hot packing including a plurality of hot packing bag bodies and an electric heating structure, and the contents of the bag bodies being sodium acetate solution and iron plate, characterized in that the surrounding edges of the hot packing bag bodies are connectedly sealed and a separate lamination layer is formed between a bag body with a second bag body for the mounting of an electric heating plate, a fastening ring for fastening is provided at the wire passage area for the hot packing bag and the electric heating plate so as to completely seal the bag body to avoid leakage and the electric heating plate is provided with a temperature control element, and an external connected temperature regulator and timer so as to effectively control the heat emission of the electric heating plate at a specific temperature so as to avoid excessive temperature to break the bag body.

### BACKGROUND OF THE INVENTION

(a) Field of the Invention

The present invention relates to an improved structure of a hot packing bag, and in particular, a packing bag which has not packing effect and with temperature control, timing and sealing function and evenly heat conduction function.

(b) Description of the Prior Art

Conventional sodium acetate solution hot packing bag essentially contains sodium acetate and an iron plate. In application, the iron plate is pressed to produce a vibration causing the sodium acetate to become crystallization with an appropriate temperature for hot packing function. However, after the packing bag has been used, the product has to be heated with hot water or microwaved to an appropriate temperature to restore to its solution state for next application. If no heating device is available, the hot packing bag cannot provide normal function. This is a major drawback of the conventional art. However, there are products with heat emission elements. The wire of the heat emission element passes through the sealed opening and connects to an external power source. The wire of the power source passed through the sealing of the bag body causes an uneven structure and the mounting by thermal melting operation is difficult. This is because only complete sealing can avoid leakage of the contents from the bag body. In addition, the pulling of the wire may cause the sealing to break and the contents within the bag body may leak. Additionally, there is not temperature control element timer, temperature regulator, etc provided on the heat emission element to effectively control the heat emission element to emit heat at a specific temperature, which the excessive temperature may break the bag body. Accordingly, it is the aim of the present invention to mitigate the above drawbacks.

### SUMMARY OF THE INVENTION

Accordingly, It is an object of the present invention to provide an improved structure of a hot packing bag, wherein the hot packing bag contains sodium acetate or non-conductive solution, solid, and the electric heating plate is provided with temperature control element and an externally connected temperature regulator, timer, so as to effectively control heat emission of electric heating plate at a specific temperature so as to avoid excessive temperature to break the bag body.

Yet another object of the present invention is to provide an improved structure of a hot packing bag, wherein an improved structure of a hot packing including a plurality of hot packing bag bodies and an electric heating structure, and the contents of the bag bodies being sodium acetate solution and iron plate, characterized in that the surrounding edges of the hot packing bag bodies are connectedly sealed and a separate lamination layer is formed between a bag body with a second bag body for the mounting of an electric heating plate, a fastening ring for fastening is provided at the wire passage area for the hot packing bag and the electric heating plate so as to completely seal the bag body to avoid leakage and the electric heating plate is provided with a temperature control element, and an external connected temperature regulator and timer so as to effectively control the heat emission of the electric heating plate at a specific temperature so as to avoid excessive temperature to break the bag body.

A further object of the present invention is to provide an improved structure of a hot packing bag, wherein the electric heating plate has the same shape as the bag body and the heat emission object on the electric heating plate is a loop structure, allowing evenly heat emission at each corners of the bag body.

Another object of the present invention is to provide an improved structure of a hot packing bag, wherein the surface of the hot packing bag is provided with heat melting points such that the contents in the hot packing bag will not accumulate at a specific area.

A further object of the present invention is to provide an improved structure of a hot packing bag, wherein the electric heating plate is a cold/hot chip which has one face providing cold surface and one face providing hot surface, such that the hot packing bag can be rapidly restored and has a cold packing effect.

The foregoing objects and summary provide only a brief introduction to the present invention. To fully appreciate these and other objects of the present invention as well as the invention itself, all of which will become apparent to those skilled in the art, the following detailed description of the invention and the Claims should be read in conjunction with the accompanying drawings. Throughout the specification and drawings identical reference numerals refer to identical or similar parts. Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a hot packing of the present invention.

FIG. 2 is an exploded perspective view of a hot packing of the present invention.

FIG. 3 is a schematic sectional view of a hot packing of the present invention.

FIG. 4 is a bottom view of the electric-heating plate of the present invention.

FIG. 5 is a schematic view of the timer in accordance with the present invention.

FIGS. 6 and 7 are schematic views of the timer in accordance with the present invention.

### DETAILED DESCRIPTION OF THE PRESENT INVENTION

For the purpose of promoting an understanding of the principles of the invention, reference will now be made to the embodiment illustrated in the drawings. Specific language will be used to describe same. It will, nevertheless, be understood that no limitation of the scope of the invention is thereby intended, such alterations and further modifications in the illustrated device, and such further applications of the principles of the invention as illustrated herein being contemplated as would normally occur to one skilled in the art to which the invention relates.

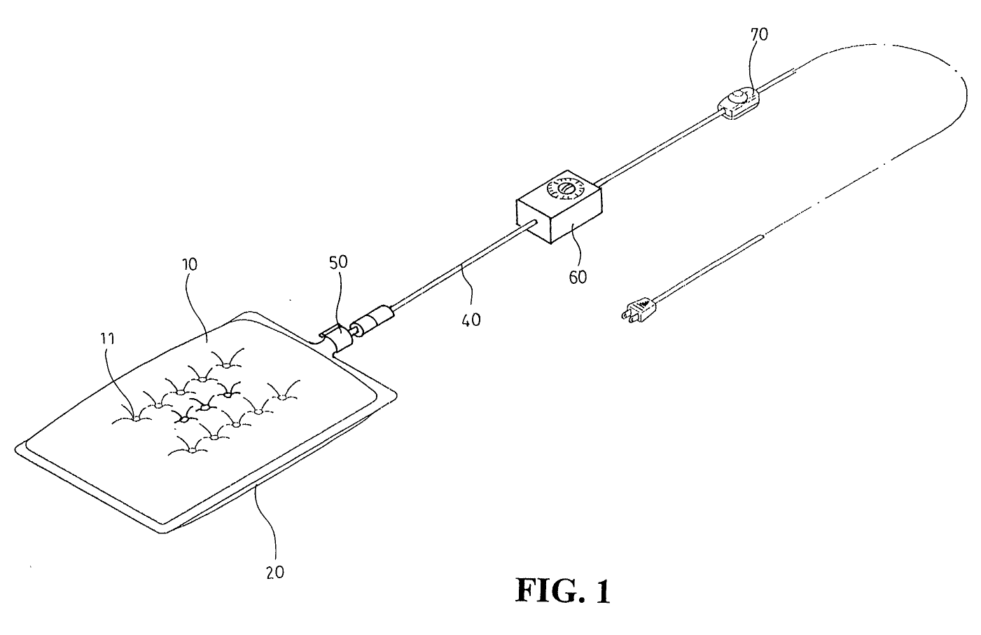

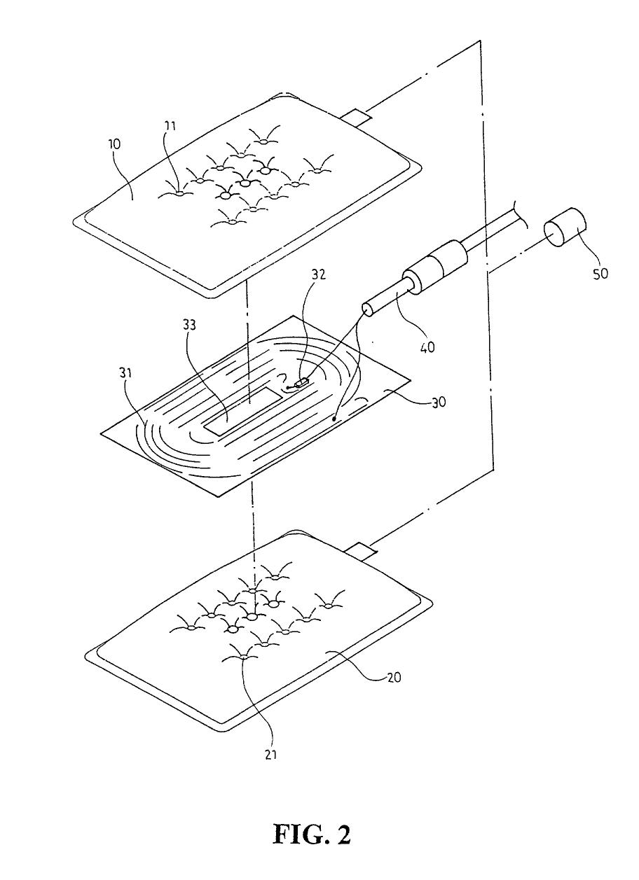

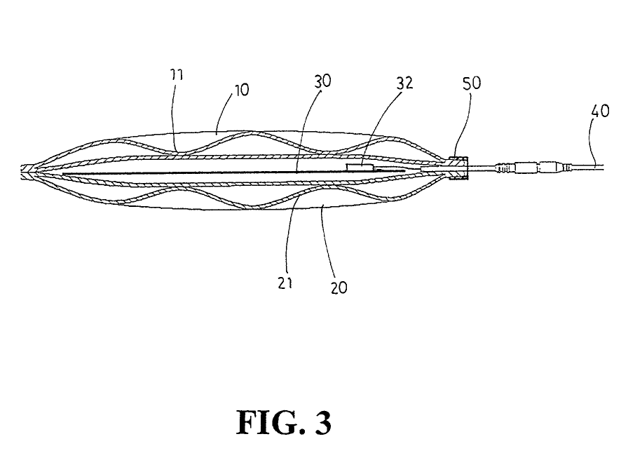

Referring to FIGS. 1, 2 and 3, there is shown an improved structure of a hot packing comprising a plurality of hot packing bags 10, 20. The hot packing bags 10, 12 contain sodium acetate solution 101, 201 of self-heat emission, and iron plates 102, 202, and also only contains non-conductive liquid (for instance, water) or solid. The surface of the hot packing bags 10, 20 are positioned with a plurality of thermal melting points 11, 21, such that the top and bottom surfaces of the bag body are combined at appropriate sections so as to avoid the contents within the bag body to accumulate at a specific area. The surrounding edge of a plurality of hot packing bags 10, 20 connectedly sealed to form into another separate lamination layer for the mounting of electric heating plate 30 (for instance flexible membrane of carbon element). Thus, the heating plate 30 is not dipped within the hot packing bags 10, 20. The hot packing bags 10, 20 can totally sealed and leakage proof. In addition, the wire 40 externally connected to the electric heating plate 30 passes through the sealed area of the two hot packing bags 10, 20. Thus, at the passage of the wire 40 is provided with a fastening ring 50 to provide the function of fastening and to entirely protect the hot packing bags 10, 20 from damages as a result of the pulling of the wire 40. The wire 40 is additionally connected with a timer 60, a temperature regulator 70 so as to effectively control the heat emission of the electric heating plate 30 at a specific temperature so as to avoid excessive temperature to break the hot packing bags. Thus the hot packing bags 10, 20 provide the function of heat packing treatment.

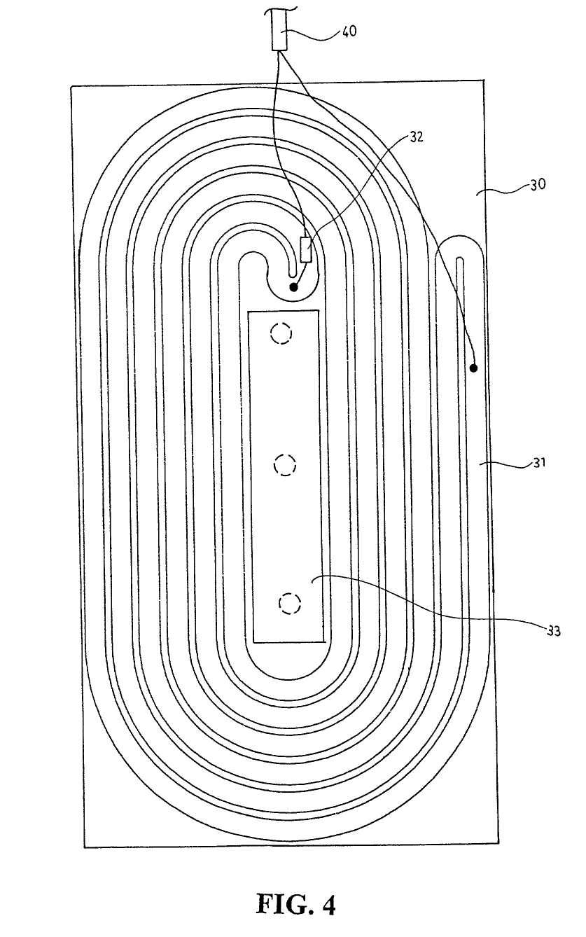

Referring to FIG. 4, the size of the electric heating plate 30 is substantially smaller than that of the hot packing bags 10, 20. The heat emission object 31 on the electric heating plate 30 is a loop shape. Thus, the heating plate 30 can provide heat evenly at every corner within the hot packing bags 10, 20. The electric heating plate 30 is provided with temperature control element 32 so as to sense the emitted temperature of the electric heating plate 30 so as to allow the user to control the electric heating plate 30 to a specific temperature so as to avoid excessive temperature of the heating plate 30 to break the hot packing bags 10, 20. In addition, the center of the electric heating plate 30 is provided with a through hole 33. Thus, the top and bottom of the hot packing bags 10, 20 are combined to each other at the through hole 33 by means of the heat melting points 11, 21.

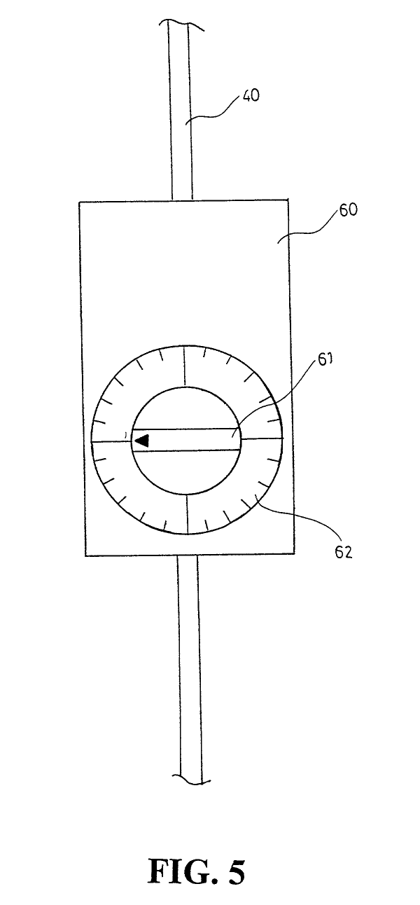

Referring to FIG. 5, the surface of the timer 60 is provided with a rotating button 61 and the surrounding edge of the rotating button 61 has markings with various type of temperature control mode so that the heating plate 30 stops emitting heat after it has reached an appropriate time. With the supplement of the temperature regulator 70, the present structure is a safe device and is electricity saving.

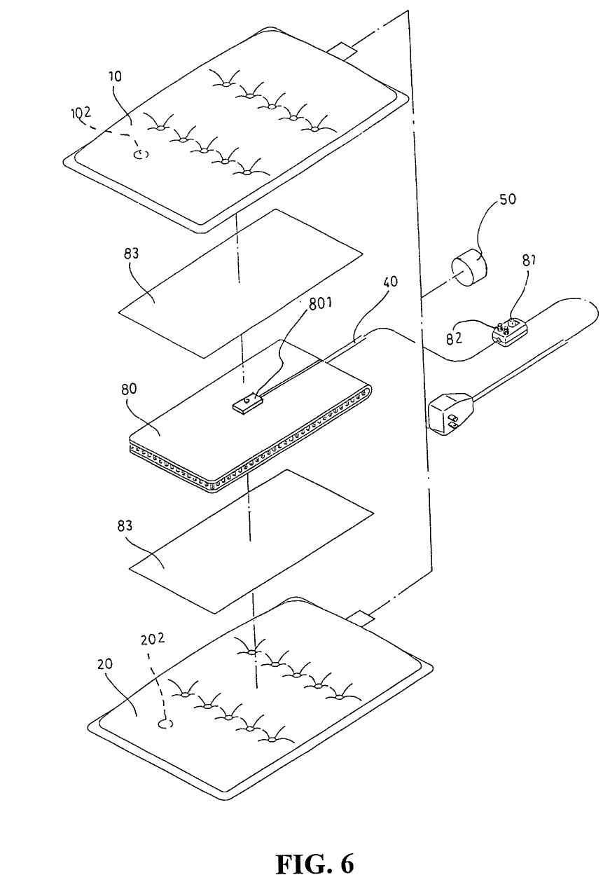

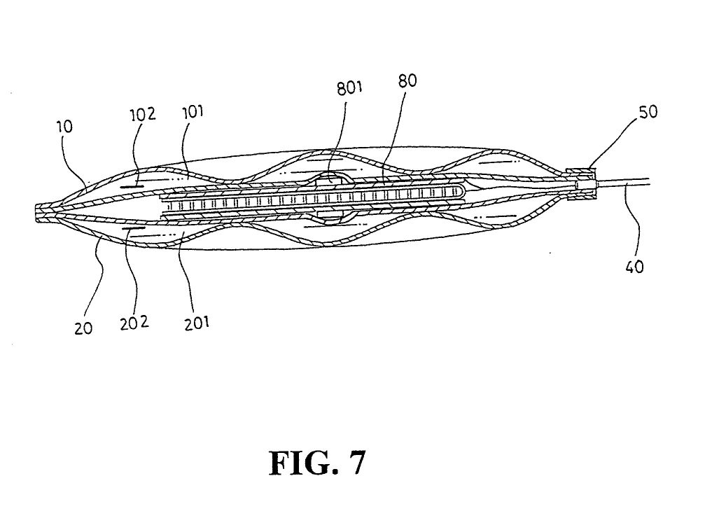

Referring to FIGS. 6 and 7, the electric heating plate 30 can be substituted with semiconductor cold/hot chip 80. The semiconductor cold/hot chip 80 has a function one of a cold surface and a hot surface, and an extended regulating switch 81 is provided for switching function, such that the cold/hot surface can be interchanged. The surface of the cold/hot chip 80 is provided with temperature control element 801 to sense the temperature of the cold/hot chip 80. Thus, by means of the operation of the temperature control button 82, the cold/hot chip 80 will not produce excessive temperature, avoiding the melting of hot packing bags 10, 20.

As can be seen from FIG. 7, the top and bottom surface of the cold/hot chip 80 are located near to the hot packing bags 10, 20 and are adhered with heat-reduction plate 83 to avoid the excessive heat from melting the hot packing bags 10, 20.

In actual application, if sodium acetate solution within the hot packing bags 10, 20 (any one) becomes crystallized state after utilization, the surface with heat energy produced by the cold/hot chip 80 will rapidly restore the hot packing bag, and the other cold surface of the cold/hot chip 80 will cause the hot packing back to provide cold packing effect Thus, the hot packing bags 10, 20 have the rapid effect of restoration and cold/hot packing function.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An improved structure of a hot packing including a plurality of hot packing bag bodies and an electric heating structure, and the contents of the bag bodies being sodium acetate solution and iron plate, characterized in that
the surrounding edges of the hot packing bag bodies are connectedly sealed and a separate lamination layer is formed between a bag body with a second bag body for the mounting of an electric heating plate, a fastening ring for fastening is provided at the wire passage area for the hot packing bag and the electric heating plate so as to completely seal the bag body to avoid leakage and the electric heating plate is provided with a temperature control element, and an external connected temperature regulator and timer so as to effectively control the heat emission of the electric heating plate at a specific temperature so as to avoid excessive temperature to break the bag body.

2. An improved structure of a hot packing as set forth in claim 1, wherein the electric heating plate is slightly smaller than the hot packing bag and the heat emission object on the electric heating plate is a loop structure such that every corners of the hot packing back can evenly emit heat.

3. An improved structure of a hot packing as set forth in claim 1, wherein the hot packing bag surface is provided with a plurality of heat melting points such that the top and bottom surface of the hot packing bag are appropriately combined to avoid the contents of the bag body accumulate at a specific area.

4. An improved structure of a hot packing as set forth in claim 1, wherein the center of the electric heating plate is provided with an appropriate large through hole such that the top and bottom hot packing bag can be combined at the through hole by means of the heat melting points.

5. An improved structure of a hot packing as set forth in claim 1, wherein the surface of the timer is provided with a rotating button and the surrounding edge of the rotating button is provided with markings.

6. An improved structure of a hot packing as set forth in claim 1, wherein the hot packing bag contains a non-conductive liquid or solid.

7. An improved structure of a hot packing as set forth in claim 1, wherein the electric heating plate is a semiconductor cold/hot chip and the top and bottom surface of the cold/hot chip close to the hot packing bag is provided with a heat reduction plate.
